(19) United States
(12) Patent Application Publication
(10) Pub. No.: US 2006/0099496 A1
(43) Pub. Date: May 11, 2006

(54) Separator container

(76) Inventors: Paul B. Aamodt, Howard Lake, MN (US); Jeffrey A. Johanneck, Brooklyn Park, MN (US)

Correspondence Address: MEDTRONIC, INC., 710 MEDTRONIC PARK, MINNEAPOLIS, MN, 55432-9924, US

(21) Appl. No.: 11/261,811

(22) Filed: Oct. 28, 2005

Related U.S. Application Data
(60) Provisional application No. 60/623,326, filed on Oct. 29, 2004.

(51) Int. Cl. H01M 2/18

(52) U.S. Cl. 429/136; 429/142; 429/139

(57) ABSTRACT

A separator container is presented. The separator container includes a plurality of containers to alternately receive an anode plate or a cathode plate.

### INCORPORATION BY REFERENCE

This non-provisional U.S. patent application hereby claims the benefit of U.S. provisional patent application Ser. No. 60/623,326, filed Oct. 29, 2004, entitled “Flat Plate Electrochemical Cell for an Implantable Medical Device”, the contents of which are incorporated by reference herein.

### FIELD OF THE INVENTION

The present invention relates generally to an electrochemical cell such as a battery or a capacitor. More particularly, the present invention relates to a separator container for electrodes in an electrode stack of an electrochemical cell.

### BACKGROUND OF THE INVENTION

Implantable medical devices (IMDs) detect and treat a variety of medical conditions in patients. Exemplary IMDs include implantable pulse generators (IPGs) or implantable cardioverter-defibrillators (ICDs) that deliver electrical stimuli to tissue of a patient. ICDs typically include, inter alia, a control module, a battery, and a battery that are housed in a hermetically sealed container. When therapy is required by a patient, the control module signals the battery to charge the battery, which in turn discharges electrical stimuli to tissue of a patient.

The battery includes a case, an electrode stack, and a liner that mechanically immobilizes the electrode stack within the housing. The electrode stack is a repeated series of an anode plate, a cathode plate with a separator therebetween. The anode plates, the separators, and the cathode plates may slip during assembly of the electrode stack, which makes it difficult to form the electrode stack. It is therefore desirable to develop a system that overcomes this limitation.

### BRIEF DESCRIPTION OF THE DRAWINGS

The present invention will become more fully understood from the detailed description and the accompanying drawings, wherein:

FIG. 1 is a top perspective view of an electrochemical cell;

FIG. 2 is a side perspective view of an exemplary separator container for the electrochemical cell depicted in FIG. 1;

FIG. 3 is a top view of a first end of the separator container depicted in FIG. 2;

FIGS. 4 through 6C are enlarged perspective views of individual containers of the separator container depicted in FIG. 2;

FIG. 7 depicts a top perspective view of a tab slot formed in a polymer later;

FIG. 8 is a top perspective view of a fold in the polymer layer of FIG. 7;

FIG. 8 is a block diagram for a system that forms a separator container; and

FIG. 10 is a flow diagram for forming an electrode container.

### DETAILED DESCRIPTION

The following description of the embodiments is merely exemplary in nature and is in no way intended to limit the invention, its application, or uses. For purposes of clarity, the same reference numbers are used in the drawings to identify similar elements. As used herein, the term “module” refers to an application specific integrated circuit (ASIC), an electronic circuit, a processor (shared, dedicated, or group) and memory that execute one or more software or firmware programs, a combinational logic circuit, or other suitable components that provide the described functionality.

The present invention is directed to a separator container that includes a series of individual containers for each anode plate and cathode plate. Anode and cathode plates are alternately inserted into individual containers of the separator container. Reduction in assembly cost of the electrode stack is realized by implementation of the separator container. Additionally, quality of the electrode stack is increased by substantially immobilizing and positioning each anode plate and cathode plate in their proper position. The separator container applies to low, medium, and high current rate batteries.

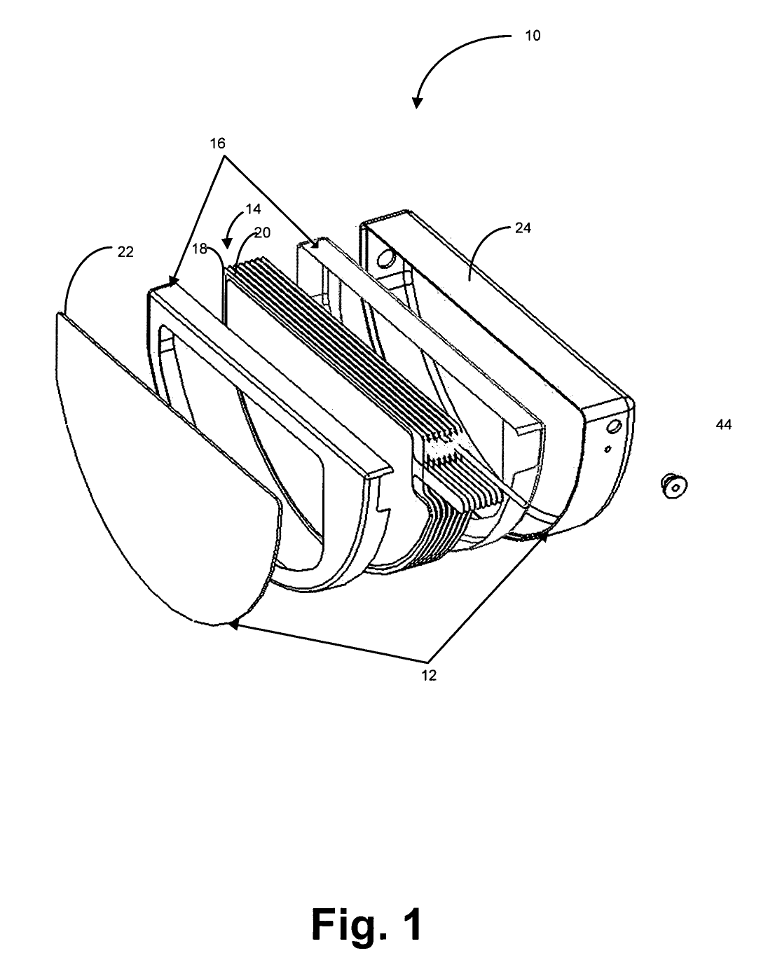

FIG. 1 depicts an exemplary electrochemical cell 10 for an implantable medical device (IMD). Electrochemical cell 10 (e.g., battery, capacitor etc.) includes a housing 12, an electrode stack 14, and a liner 16. Housing 12 is formed of a first portion 22 (top) welded to a second portion 24 (bottom). Liner 16 surrounds electrode stack 14 to prevent direct contact between electrode stack 14 and housing 12. A detailed example of such a configuration may be seen with respect to U.S. Pat. No. 6,459,566B1 issued to Casby et al. and U.S. Patent Publication No. 2003/0199941A1, and assigned to the assignee of the present invention, the disclosure of which is incorporated by reference, in relevant parts.

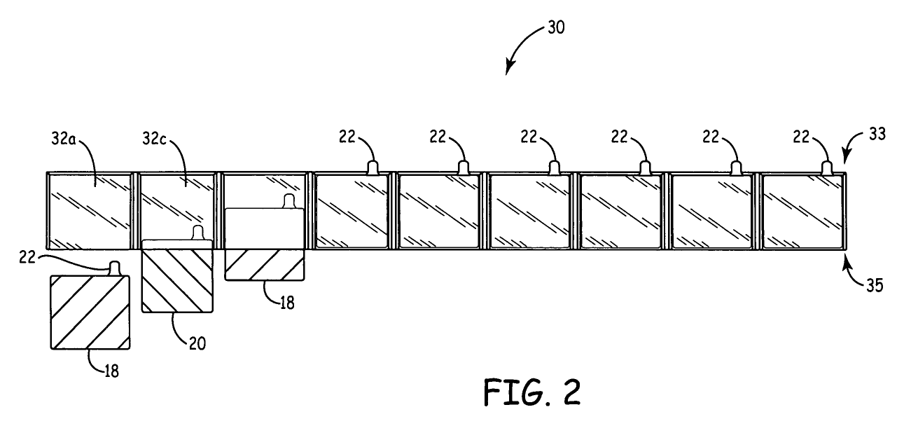

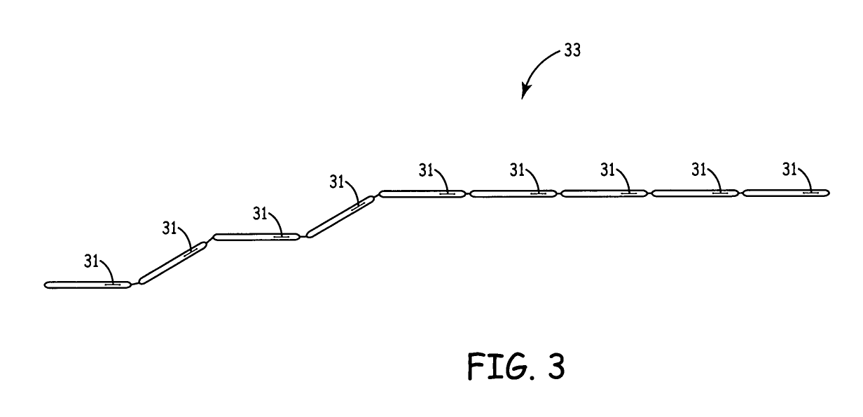

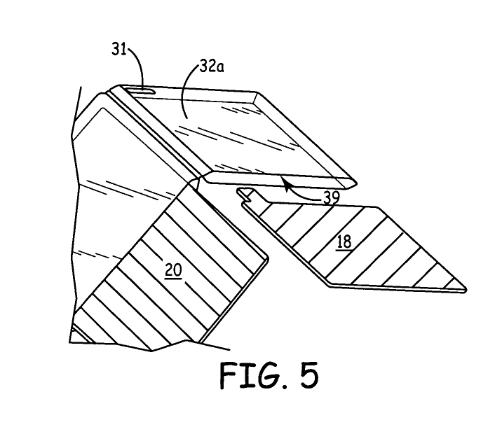

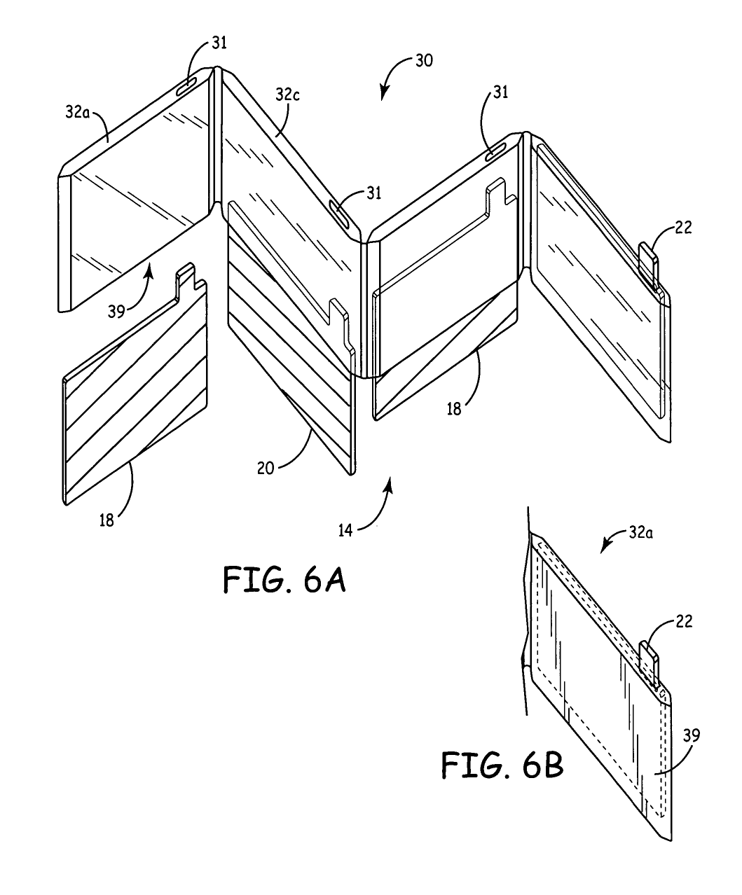

Referring to FIGS. 2 through 6B, electrode stack 14 includes electrode separator container (ESC) 30 to insulate anode plates 18 from cathode plates 20. ESC 30 is a polymer (e.g. polyethylene etc.) that allows ionic exchange to occur during an electrochemical reaction between electrolytes, anode plate 18, and cathode plate 20. ESC 30 comprises a first end 33, a second end 37, and a plurality of individual containers 32a and 32c configured to alternately receive anode plates 18, 20, respectively. First end 33 opposes a top portion 22 (or lid) of housing 12. First end 33 includes a plurality of tab slots 31 from which tabs 37 of anode and cathode plates extend therethrough. Second end 33 is disposed at a bottom 24 of housing 12.

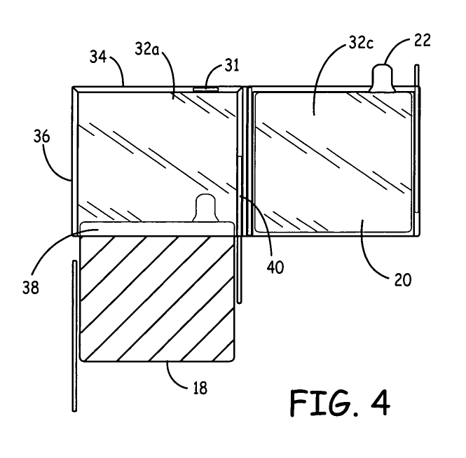

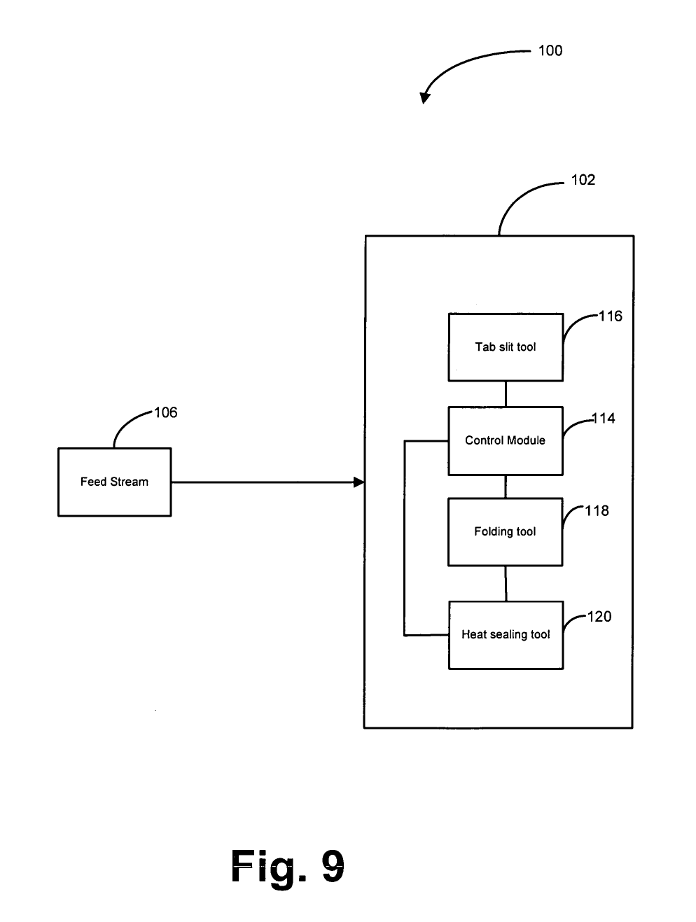

Container 32a, as depicted in FIG. 4, includes first, second, third, and fourth sides 34, 36, 38 and 40. First side 34 is equal in length to third side 38 whereas second side 36 is equal in length to fourth side 40. Third side 38 is formed by folding separator material 50, as shown in FIG. 8. Sides 36 and 40 are heat sealed. Adequate heat sealing may depend upon the type of polymer selected to form ESC 30. Exemplary polymer material includes Celgard 2500 commercially available from Celgard located in Charlotte, N.C. Generally, adequate heat sealing may be determined by an opaque polymer becoming transparent or clear. Sufficient heat sealing may also be determined by visually verifying that heat sealed sides 36, 40 are closed or fused. Anode plate 18 is then inserted into pocket 54 formed by sides 34, 36, and 40. Side 38 is then heat sealed to close pocket 54. A similar process is applied to cathode plate 20.

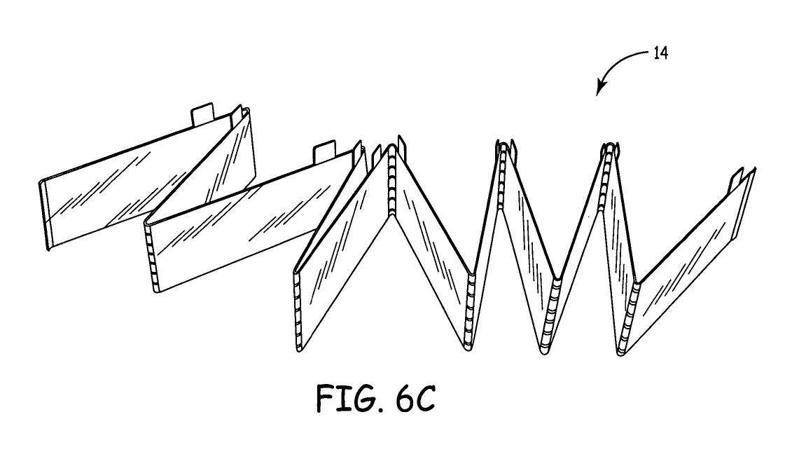

Referring briefly to FIGS. 6A and 6C, ESC 30 is depicted in a “zig-zag” form before being collapsed to form electrode stack 14 as shown in FIG. 1. ESC 30 ensures tabs 22 are properly aligned when electrode stack 14 is formed.

FIG. 9 depicts a system 100 for automatically forming separator container 30. System 100 includes feed stream 106 (e.g. a polymer layer), and separator container device 102 that automatically creates the separator container 30. Separator container device 102 includes control module 114, tab slit tool 116, folding tool 118, and heat sealing tool 120.

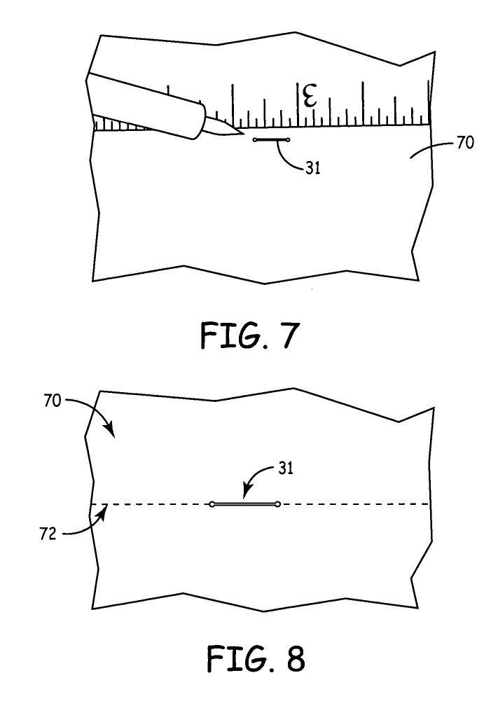

Feed stream 106 such as a polymer layer 70 depicted in FIGS. 7 and 8 is fed into separator container device 102. Separator container device 102 automatically aligns polymer layer 70 and moves polymer layer 70 along a flat surface 72 into position under tab slit tool 116. Movement of polymer layer 70 may be by a conveyor belt (not shown). Tab slit tool 116 automatically forms a series of slits along a width of polymer layer 70. A set of apertures or tab slots 31 is created. Polymer layer 70 is then moved to folding tool 118 and folded such that the fold, along line 72, includes set of apertures 31. Heat sealing tool 120 then heat seals at least two sides to create a pocket 54 in order to receive an electrode plate such as anode plate or a cathode plate. Generally, electrode container 20 reduces assembly cost and improves the quality of electrochemical cell 10.

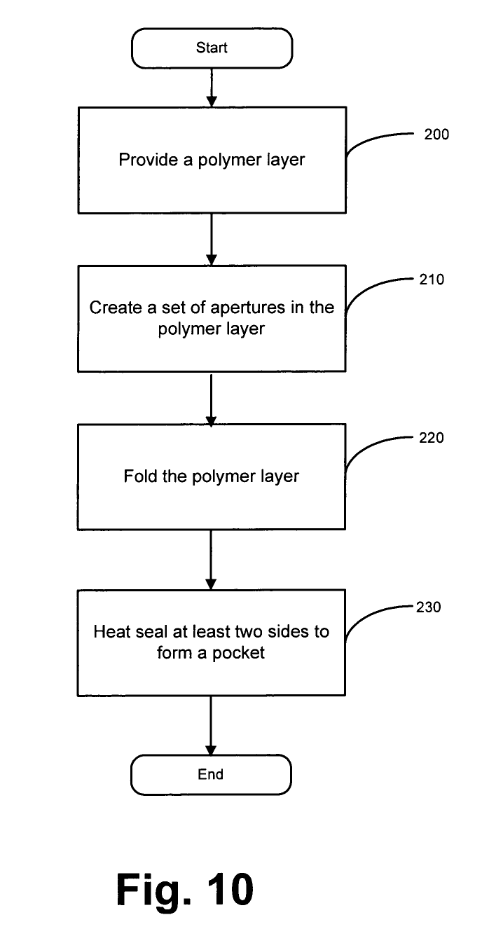

FIG. 10 is a flow diagram for forming and electrode stack container. At block 200, a polymer layer is provided. At block 210, a set of apertures is created. At block 220, the polymer layer is folded such that the fold includes the set of apertures. At block 230, a set of pockets are created by heat sealing at least two sides for each predetermined container.

While the invention has been described in its presently preferred form, it will be understood that the invention is capable of modification without departing from the spirit of the invention as set forth in the appended claims.

What is claimed is:

1. A battery comprising:
a housing;
an electrode stack disposed within the housing, the electrode stack includes a first anode plate coupled to a first anode separator container and a first cathode plate coupled to a first separator cathode container, the first anode separator container includes an anode pocket for receiving the first anode plate and the first cathode separator container includes a cathode pocket for receiving the first cathode plate.

2. The battery of claim 1, the first anode separator container includes a first side, a second side, a third side, and a fourth side.

3. The battery of claim 2, the first anode separator container includes an aperture on the first side to allow an anode tab to extend therethrough.

4. The battery of claim 2, wherein the second side, the third side, and the fourth side are closed.

5. The battery of claim 3, wherein the first side being closed except for the aperture.

6. The battery of claim 1, the first anode separator container and the first separator cathode formed from a same continuous sheet of separator material.

7. The battery of claim 1, the first anode separator container includes a first side, a second side, a third side, and a fourth side, the first side includes an aperture.

8. The battery of claim 7, wherein the second side, the third side, and the fourth side are heat sealed.

9. The battery of claim 7, wherein the second side, the third side, and the fourth side are heat sealed.

10. The battery of claim 7, wherein the heat seals are transparent.

11. An apparatus for automatically producing a set of separator containers to receive at least one anode and at least one cathode comprising:
storage media including instructions stored thereon which when executed cause a computer system to perform a method including:
providing a polymer layer;
creating a set of apertures;
folding the polymer layer so that a fold includes the set of apertures; and
creating a set of pockets.

12. The apparatus of claim 11, wherein each pocket includes a first side, a second side, a third side, and a fourth side, the first side includes an aperture.

13. The apparatus of claim 12, wherein the second side, the third side, and the fourth side being heat sealed.

14. The apparatus of claim 13, wherein the heat seals being transparent.

15. The apparatus of claim 13, wherein the heat seals being transparent.

16. The apparatus of claim 14, wherein an adequate heat seal sufficiently closes one of the first side, the second side, the third side, and the fourth side.

17. An electrode separator container comprising:
a first container that includes a first pocket configured to receive an anode plate, the first container includes a slot for a tab from the anode plate to extend therethrough; and
a second container that shares a heat sealed side with the first container, the second container includes a second pocket configured to receive a cathode plate, the second container includes a slot for a tab from the cathode plate to extend therethrough.

18. The electrode separator container of claim 17, wherein the first container includes a first side, a second side, a third side, and a fourth side, the first side includes an aperture.

19. The electrode separator container of claim 18, further comprising:
a third container shares a heat sealed side with the second container;
a fourth container shares a heat sealed side with the third container,
wherein the first container, the second container, the third container, and the fourth container collapsed in a zig zag form.

20. The apparatus of claim 12, wherein the second side, the third side, and the fourth side of the first container being heat sealed.

21. A separator container comprising:
a first container that includes a pocket to receive an electrode plate.
